(19) United States
(12) Patent Application Publication
(10) Pub. No.: US 2003/0231151 A1
(43) Pub. Date: Dec. 18, 2003

(54) Apparatus and method for light enhancing

(76) Inventors: James E. Barlow, Las Vegas, NV (US); Richard E. Albrecht, Chapel Hill, NC (US)

Correspondence Address: Charles H. McCrea, Jr., Mikohn Gaming Corporation, P.O. Box 98686, Las Vegas, NV, 89193-8686, US

(21) Appl. No.: 10/173,083

(22) Filed: Jun. 17, 2002

(51) Int. Cl. G09G 3/32

(52) U.S. Cl. 345/82

(57) ABSTRACT

An apparatus and method for absorbing downwardly cast ambient received at a visual display with a light shade cantilever off a base carrying a printed circuit board with driving circuitry. A plurality of light emitting diodes in a pixel group electrically couple to the printed circuit boards for selective operation. The light shade mounted above each pixel group reduces and prevents reflection of downwardly cast ambient light received. Narrow crevices with acutely angled opposite light reflective surfaces receive and reflect downwardly cast ambient light toward the narrow crevice positioned whereat each pair of light reflective surfaces join. The light shade with adjacent pairs of opposed light reflective surfaces also join at a plurality of sharp edges facing up and forming a series of “WWW”.

### CROSS REFERENCE TO RELATED APPLICATIONS

METHOD AND APPARATUS FOR LIGHT ABSORBING U.S. Ser. No. 09/964,004 filed on Sep. 25, 2001.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to methods and apparatus for enhancing light output from light emitting diodes in pixel groups in a visual display by passive control of contrast. More particularly, to enhance light output by control of reflections of downwardly cast ambient light that diminishes contrast.

2. Description of Related Art Including Information Disclosed Under 37 CFR 1.97 AND 1.98

Visual display systems exist providing moving images in color, for example, a television show or videotape and such display signs have not provided large vivid video images, especially those subject to ambient outdoor or inside light. In particular, visual displays designed for outdoor and indoor use have been prohibitively expensive to operate, to purchase, and to maintain. Lack of brightness is a serious problem for visual displays. Reflected light from other sources, especially other signs, the sun, the moon and other lights on the ceiling or on adjacent structures reduce the ability of viewers to perceive the pictures displayed by the sign. These visual displays have of a plurality of lighting units, some of which are turned off, and therefore black, at any particular moment, and some that are illuminated with color and at various brightness levels in order to show the picture.

In U.S. Pat. No. 4,621898 a radiant energy filter is formed from a transparent plate for high filtration efficiency. The plate has a plurality of etched grooves with a light absorbency for energy radiating toward the grooves from within the plate. Therefore, light entering the plate from an angle that would cause it to impinge upon the grooves is highly attenuated and light entering the plate and not impinging upon the grooves is attenuated only by the optical characteristics of the plate. Thus there is attenuation of light entering from beyond a view range, as compared with light reflected to a view range. The background of this patent is of particular instructive with respect to attenuation filters and so it and the entire disclosure of U.S. Pat. No. 4,621,898 is incorporated herein by reference and made a part hereof.

U.S. Pat. No. 5,745,293 has a light trap for a parallel light beam including an entry with a frustoconical opening and a conical body attached to a back wall of the trap. The opening narrows with a cone angle from the outside towards the inside and has at the outside its diameter equals to the diameter of the light beam. The conical body reflects light uniformly in all directions. Thus, unwanted light is a nuisance as it can disturb the processing operations by generating spurious images in processing devices or by modifying the luminous intensity in instruments for measuring intensity.

U.S. Pat. No. 4,142,781 has a thin synthetic material plate of fluorescent materials to trap or collect ambient light. The trapped light is sent effectively to exit visibly and measurably at arbitrary points on the plate. A fluorescent plate of this type in passive electro-optical displays, that function as light valves, creates a visual display having an increased ambient brightness adaptive illuminous density as electrically regulated or controlled between a light transmission state and a light scattering or blocking state.

U.S. Pat. No. 5,877,829 has an liquid crystal display with a light source, a first optical element for collimating light emitted from the source and restricting the direction of emission of the light entering the first optical element to the direction of the normal axis thereof. The first optical element is between and parallel to the light source and the liquid crystal display so illumination is substantially by light travelling along the normal axis of the liquid crystal display. The directionality of the emission from the first optical element determines the directionality of the light going out and has the highest intensity of the liquid crystal display. If seen from any other direction, no light reaches the observer, so that the liquid crystal display seems black as if the light source was not activated. By using such a first optical element having directionality, it becomes impossible to observe the display content from directions other than the intended direction, regardless of the narrow or broad viewing angle characteristics of the liquid crystal display.

U. S. Pat. No. 5,882,105 has a visual display lighting system of a series of individual lighting modules each with a printed circuit board containing drive circuitry and a plurality of light sources wherein each module has a reflector unit for each light source and a covering lens. A pair of retainers locks to the ends of a lighting panel to hold the module in the system. The retainers quickly release from the ends when the module is removed from the front of the system. The lighting panel has clips for locking the printed circuit board and it holds the plurality of light sources into the lighting panel. The printed circuit board can be quickly released and removed from the rear of the system.

U.S. Pat. No. 5,947,592 has a visual display with a lighting unit including a reflector that is nearly completely sealed and has a reflecting surface that spreads the emitted light about eight degrees from the plane of circumference of the reflector. To cool the lighting unit, air is directed along the rear surface of the sealed reflector so a small amount of the air enters the sealed reflector, causing a buildup of pressure inside the reflector and preventing any additional air from entering the reflector. The lighting units are attached to the visual display at a downward angle of about eight degrees from the horizontal.

The disclosures of these listed patents are incorporated by reference and made a part hereof.

Ambient light reduces the contrast of outdoor signs in two ways. First, when a lighting unit is off, the blackness of the lighting unit is only as dark as the downwardly cast ambient light reflected from that unlit visual display or portions thereof. Second, when it is lit, colors mix with the downwardly cast ambient illumination and tend to wash out the richness of the visual display. Thus, the unwanted external light reflections and mixing diminish the contrast of the picture, causing the viewer to have difficulty perceiving the picture being displayed, especially when that picture is a video or moving picture in color. Thus, a need exists for a lighting unit that will enhance the contrast ratio of the visual display, without using components expensive to add or operate. The contrast ratio is the sum of the light from the visual display plus the downwardly cast ambient light reflected divided by the downwardly cast ambient light reflected. Consequently, the brightness of the visual display increases with decreasing reflection of ambient light and with less ambient light available to mix with the illuminated image.

A need remains for large visual displays capable of showing moving images that can be located outdoors at remote locations such as on a building or on a free standing pylon or located indoors in large buildings such as arenas or casinos. All such signs are subject to downwardly cast ambient illumination that reduces the contrast and thus apparent brightness of light emitting diode visual,displays. Typically the bulk of the amount of downwardly cast ambient light comes from above the visual display whether indoor or outside.

A need exists to enhance the apparent brightness as seen from in front of visual display signs with light emitting diodes used to form images subject to downwardly cast ambient light from above. Many light emitting diodes in pixel groups couple to electronic drive circuitry form large signs driven by processors to display varying images, such as a very large television picture and similar signage.

A need also exists to build a universal sign with a large visual display showing moving images that mount to a variety of structures without regard to if the light emitting diodes in the sign are subject to varying downwardly cast ambient light conditions primarily from above. A light enhancement reduces or eliminates reflection or glare due to such downwardly cast ambient light conditions shining on the sign.

Added to difficulties in seeing moving pictures on outdoor signs under downwardly cast ambient light that wash out the light from the sign, viewers often find it difficult to see the picture when viewed from an angle other than directly in front of the sign. If viewed by standing below and close to the sign or passing by the side of the sign, most of the light radiated from the light sources is directed toward the front of the sign or it would be diffused too far from the edges of the light sources.

Under the teachings of the present invention, a visual display is disclosed solving the above needs by providing light sources that are covered by a light shade to reduce or eliminate reflections of downwardly cast ambient light from above thereby increasing the contrast ratio. Affordable light sources used in visual displays must provide highly visible moving pictures at the NTSC standard 30 images per second for indoor and outdoor lighting conditions. The light emitting diode pixel groups preferably have a downward angle of about eight degrees from the horizontal to have bright and consistent images for viewers below or at a distance from the visual display. Thus much of the downwardly cast ambient light from eight degrees or above the light emitting diodes tends to be reflected toward viewers.

In addition, a need exists for a method to easily resist accumulation of and removal of dust from and about the light emitting diodes and their light shades as that dust would reflect or scatter downwardly cast ambient light or reduce light output from the light emitting diodes.

### BRIEF SUMMARY OF THE INVENTION

The concept of a light absorber for a visual display was disclosed on the identified related application. This disclosure concerns a specific improvement thereof wherein a light shade positioned above each light emitting diode pixel group receives and absorbs light coming towards the visual display from primarily above and thereby eliminates or substantially reduces reflection of and/or mixing of that downwardly cast ambient. Downwardly cast illumination comes from ceiling fixtures (inside) or the sky and sun (outside). It has been found that most of the reflections received by viewers of visual displays comes from the downwardly cast ambient light. Also light from standard indoor lighting ceiling fixtures is primarily cast downwardly and so would likewise come from above the visual display signs. Control of such downwardly cast ambient light can significantly enhance contrast and improve the visibility of the visual display for viewers in front and there beneath. The visual display disclosed includes a series of individual light emitting diodes preferably in pixel groups of light emitting diodes. Each pixel is the single dot of light on the visual display. All images are made up of a collection of pixels, with each pixel being either off (dark) or on (illuminated, possibly in color). The number of pixels available determines the resolution of the visual display.

Each of the light emitting diodes electrically couples to a printed circuit board containing drive circuitry and with other adjacent light emitting diodes is a pixel group. The preferred visual display of the present invention has groups of typical three light emitting diodes called as each pixel.

Unlike incandescent bulbs, that waste a large share of the energy they consume warming a filament, light emitting diodes produce relatively little heat, meaning a greater amount of their energy is used to produce light. With the cost of electrical power increasing substantially, it is timely to make the visual displays more energy efficient, as it does not take too long to recoup the investment in efficient light emitting diodes. Light emitting diodes also last much longer than conventional filament bulbs, reducing maintenance costs and servicing disruptions caused by crews replacing incandescent bulbs. The life expectancy of the light emitting diodes is at least ten years and as much as fifteen years.

Light emitting diode visual displays include arrays of several colors of diodes (red, blue and green) wherein each light emitting diode is smaller than a pushpin. The colors can be independently illuminated and the light of several can blend to form all of the different colors in the visual displays of words and/or pictures. Each light emitting diode contains a bit of semi-conducting material; usually gallium that releases red, amber or green light as current excites the atoms of the semi-conducting material. The semi-conductor includes a clear plastic housing as a lens to concentrate the light toward the direction of observers, making each light emitting diode appear brighter. As the cost of semi-conductors has fallen, the price of energy has risen. Light emitting diodes for signage has become cost effective. Because of the potential energy savings, light emitting diodes in new signs and retrofitting are viable. The increased brightness and truer colors are added pluses.

The visual display has preferably a video, a message board, or combination of both. The visual display may be any type of plurality of light emitting diodes as a signal such as a stop and go lights, automotive turn or brake signal lights or cautionary road or traffic lights that might be impaired by reflection of downwardly cast ambient light. Thus, the reduction of the effects of such downwardly cast ambient light on the visual display increases the visibility of the information delivery or signals presented. The minimization of reflections passively minimizes the amount of energy required to provide signals or adequate displays and improves clarity all at less cost.

Light shades disclosed are above the light emitting diodes for maximum control of reflection of downwardly cast ambient light from above. As the visual displays are mounted above the viewers, each is directed at an angle to the ground so that the pictures displayed can be easily seen by viewers. Light shades are preferably mounted over each light emitting diode arrays or pixel group. Arrays of light emitting diodes may each consist of three or more of different colors carried on a printed circuit board each light emitting diode connected by its electrical coupling terminals.

A support preferably carries bases for the pixel groups in the visual display in position for observation of the visual display from locations generally in front of and below. The support is preferably a sheet with a panel like shape with a plurality of spaced rectangular openings on, for example, two-inch centers horizontally and vertically for receiving a rear portion of each base in a snap engagement. Vertical as used herein is with respect to the horizon but as disclosed the visual display support may preferably angle toward the observer and still be substantially vertical. Each base is generally hollow and cube shape with a front facing light emitting diode pixel group and the rear portion engagement. At least one printed circuit board for each pixel group is carried on the support toward the rear portion and the printed circuit board may include driving circuitry for the visual display. A plurality of light emitting diodes are most preferably each coupled to the each printed circuit board by wire terminals so that each printed circuit board holds at least one pixel group. Each printed circuit board might include electronic drive circuitry for controlling the delivery of power to the plurality of light emitting diodes.

A light shade extends forwardly from the support cantilever over lenses of the light emitting diodes. Thus the printed circuit board is spaced back from the lens by the terminals while the printed circuit board is normal to the generally horizontal light shade located above the plurality of light emitting diodes. The light shade most preferably is configured for shading each of the plurality of light emitting diodes from downwardly cast ambient light. The light shade preferably has at least one narrow cranny for absorbing downwardly cast ambient light received by the visual display from locations generally above the visual display to prevent the downwardly cast ambient light from being reflecting therefrom for observation by viewers. The light shade most preferably has a plurality of light reflective surfaces facing locations generally above the visual display. Pairs of light reflective surfaces are preferably opposed at an acute angle so as to receive downwardly cast ambient light and reflect it between the opposed light reflective surfaces and toward the narrow cranny positioned whereat the pairs of light reflective surfaces join. The adjacent pairs of opposite light reflective surfaces preferably join at a plurality of sharp edges facing upwardly relative to the visual display and extending normal to the observed surface thereof. As viewed close up in cross section or from in front the leading edge of the plurality of adjacent pairs of opposed light reflective surfaces preferably appear as a series of connected “WWW” configurations facing upwardly. A sharp front end on the light shade is preferred to minimize the surface of the “WWW” configurations from reflecting light. The plurality of sharp edges when facing locations generally above of the visual display they angle slightly toward the overhead light if view from a side. The angularity may be adjusted for trapping most of the incoming downwardly cast ambient light from locations generally above the visual display but an obtuse angle relative to the a plane of the display is preferred particularly because the plane is slightly angled downward toward observers.

The trapping of downwardly cast ambient light assures that dark areas of shade appear when observed. The dark areas of shade are primarily about each of the pixel groups formed of light emitting diodes. The plurality of sharp edges split received downwardly cast ambient light and the pairs of reflective surfaces in combination with the narrow crannies located inwardly of the plurality of sharp edges trap the light. The light shade as positioned extends over, like a visor or eve each light emitting diode array pixel group to trap received downwardly cast ambient light. The plurality of sharp edges alternately may be located generally in a horizontal plane cantilever above the generally vertical pixel groups. Generally vertical means with reference to the disclosed embodiment is angled slightly toward the observer or as shown normal to the line of sight and not true vertical. It is preferred that the base also have a series of horizontally disposed “WWW” configurations facing outwardly to capture any light and minimize reflection. The related application, METHOD AND APPARATUS FOR LIGHT ABSORBING U.S. Ser. No. 09/964,004 filed on Sep. 25, 2001 is incorporated herein by reference and made a part hereof as it includes a disclosure of the horizontally disposed “WWW” configurations.

A method of shading downwardly cast ambient light received on a lighted visual display may have steps including shading each of the plurality of light emitting diodes with the light shade disposed for trapping light from locations generally above the visual display. The step of shaping the light shade to reduce reflection of downwardly cast ambient light received by the visual display from locations generally above of the visual display prevents reflecting light toward observers. Including on the light shade at least one narrow cranny facing upwardly for absorbing light from above is a step in the method. The preferred steps of having on the light shade a plurality of light reflective surfaces facing up and mounting pairs of light reflective surfaces opposed at an acute angle to collect downwardly cast ambient light reflect it there between to the narrow crannies at the junctures of each pair. The steps of providing the light emitting diodes mounted to printed circuit boards having electronic drive circuitry for controlling the delivery of power are most preferred. The further step of joining adjacent pairs of opposed light reflective surfaces with a plurality of sharp edges facing locations generally above of the visual display may be practiced. The step of presenting in cross section the plurality of adjacent pairs of opposed light reflective surfaces as a series of connected “WWW” configurations so their sharp edges face up. The plurality of sharp edges preferably splitting received downwardly cast ambient light and the pairs of reflective surfaces with the narrow crannies located inwardly of the plurality of sharp edges trap ambient light.

The method may include the steps of locating a plurality of sharp edges generally horizontal about the plurality of light emitting diodes with an ovoid light pattern for the visual display. The ovoid pattern has a longer horizontal dimension. Curving the series of connected “WWW” configurations formed by the plurality of adjacent pairs of opposed light reflective surfaces in a slight arc with respect to the vertical such that when viewed in plan the curvature is dished for trapping ambient light from in front of the visual display. The light enhancement provided so that dark areas appear about each of the light emitting diodes during observation.

### BRIEF DESCRIPTION OF THE DRAWING

FIG. 1 is a perspective view illustrating the placement of the visual display for observation.

FIG. 2 is a partial perspective view of the visual display of FIG. 1 from shown from in front illustrating a front portion of one pixel group and its base shown exploded from a support for the visual display of FIG. 1 of the present invention.

FIG. 3 is a side view of the base for the pixel group shown in FIG. 2 illustrating the construction of a base with its middle portion shown partially cut away to illustrate how a printed circuit board is carried and coupled to power light emitting diodes.

FIG. 4 is a partial side view in elevation of several bases for supporting pixel groups in stacked relation and mounted to the support.

FIG. 5 is a front view of one pixel group base as seen from in front of FIG. 2.

FIG. 6 is a top plan view of the pixel group of FIG. 2.

FIG. 7 is a schematic showing of a ray trace between reflective surfaces of a light shade.

### DETAILED DESCRIPTION OF THE INVENTION

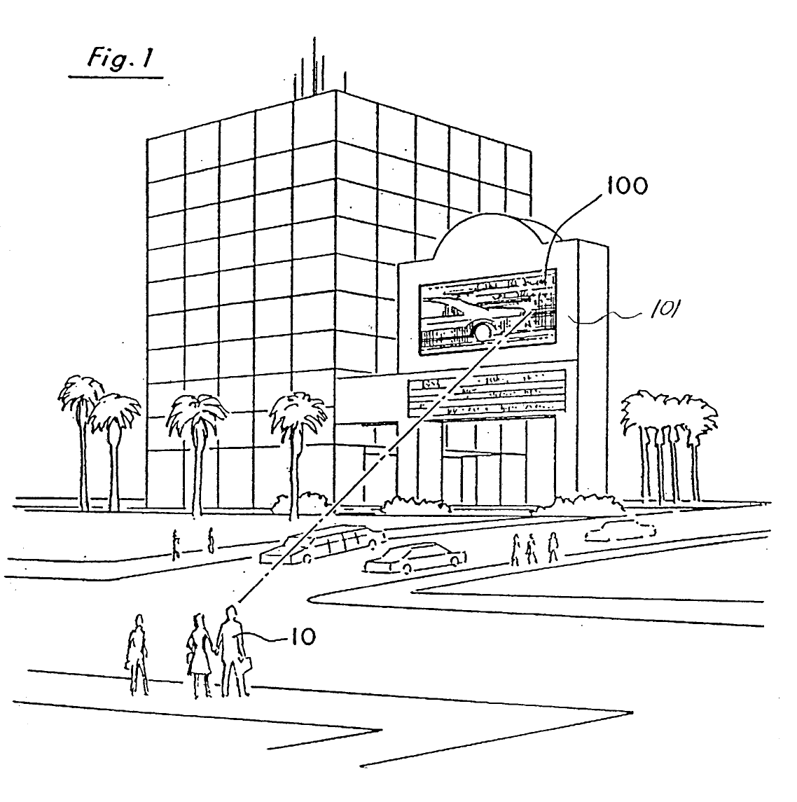

Turning to FIG. 1, a visual display 100 in accordance with the present invention is shown in a perspective view. Although the visual display 100 in FIG. 1 is shown as being in a preferred outdoor location, it is to be understood that the visual display 100 is not limited to outdoor placement and that it may also be situated within a structure. Therein the surrounding elements and support structure may vary from those shown in FIG. 1. For example, the visual display 100 can be placed flat against the exterior wall of a building or the interior wall of a room, or hang freely from the ceiling within a room, or stand atop the roof of a building. The visual display 100 is preferably situated to be easily visible to the viewers 10 who may be some distance from and below the visual display 100.

The mounting location of the visual display 100 should be convenient for cleaning or servicing and not dependent on the variation of, direction of or amount of downwardly cast ambient light to which the visual display may be subject. Hence, the present invention permits locating the visual display 100 inside, outside and toward more, less and/or varying downwardly cast ambient light conditions. The visual display 100 for observation has a structure 101 for mounting the visual display in position for observation of the visual display from locations generally in front of the visual display, as best shown in FIG. 1 by the line of sight therein included.

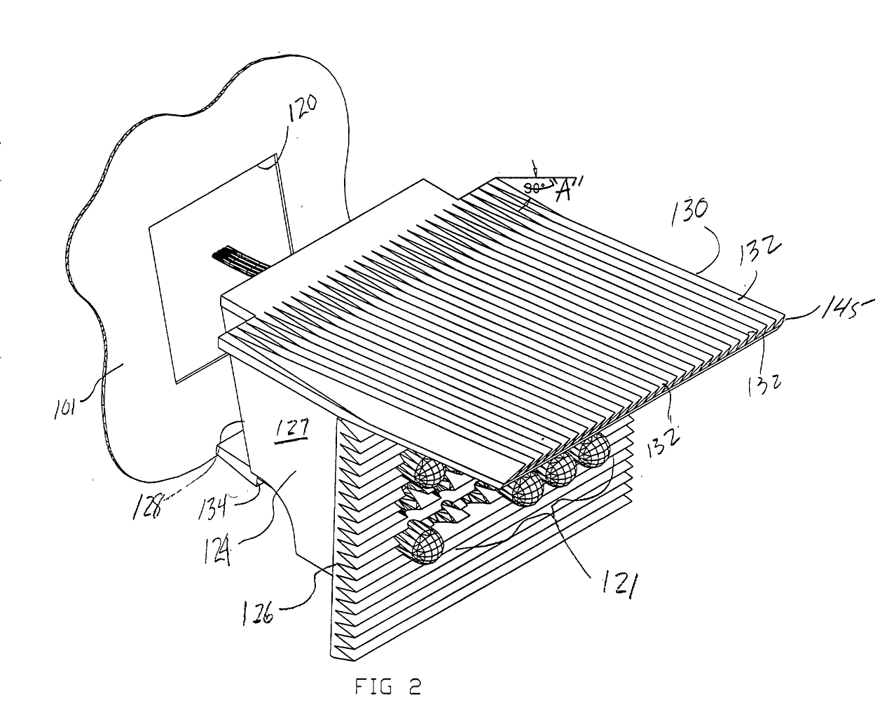

FIG. 2 illustrates a perspective view of a pixel group 121 composed of a plurality of light emitting diodes 122 for the embodiment of the visual display 100. It should be appreciated that the particular light emitting diode while important to the visual display 100 is interchangeable. With the energy conservation needs of present day, the disclosure herein includes any light emitting diode 122 that skilled artisans may, could or would know about for visual display 100 as disclosed herein after in detail.

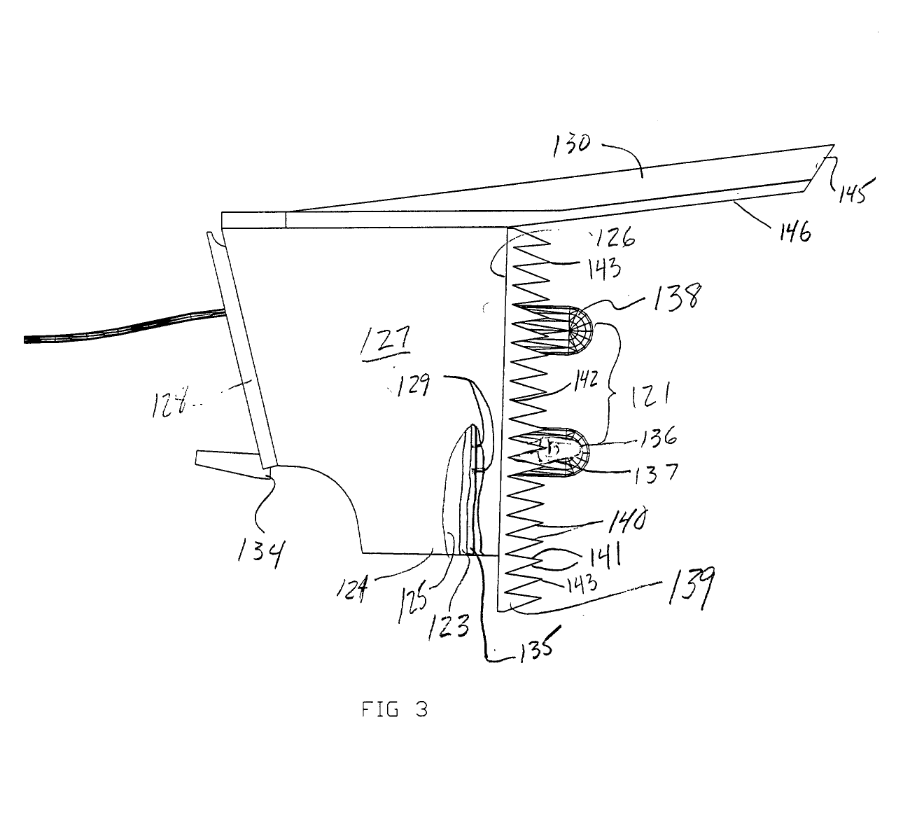

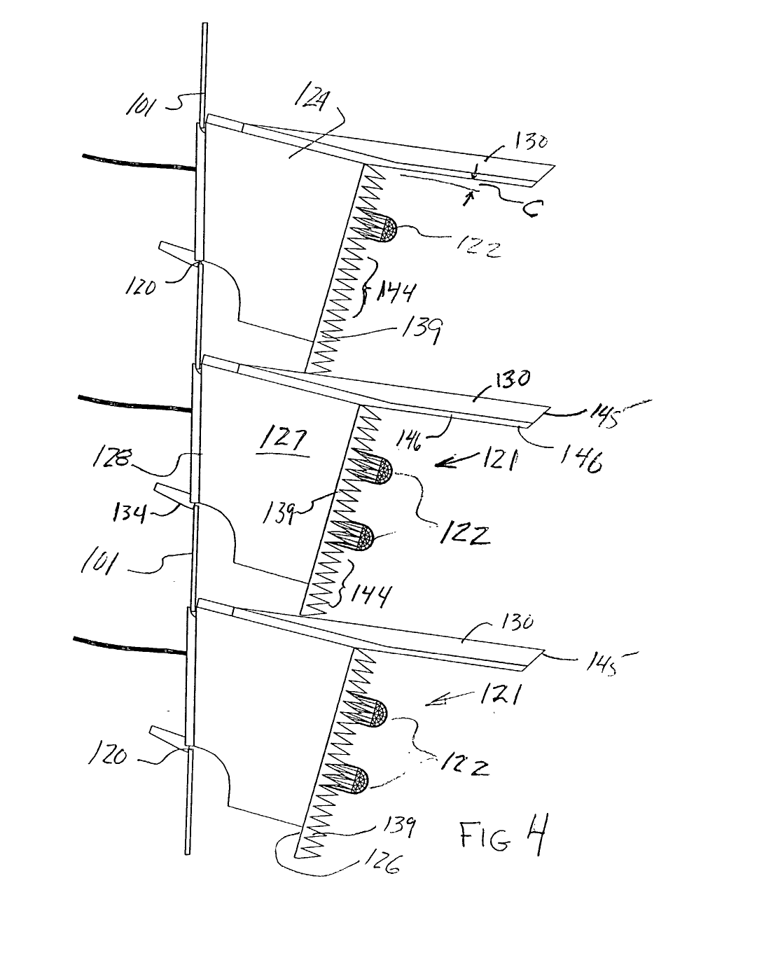

The visual display 100 for observation has a support 101 for mounting the visual display 100 in position for observation from locations generally in front and slightly below as seen in FIG. 1. A plurality of openings 120 on the support 101 are provided to carry a plurality of pixel groups 121 of light emitting diodes 122 in the visual display 100 for delivery of an image. A printed circuit board 123 is electrically coupled to each pixel group 121 for electrically driving each of the light emitting diodes 122. The partial cut away shown in FIG. 3 has the side edge of printed circuit board 123. A base 124 as shown in the partial perspective view of FIG. 2, has a generally cube shape with a hollow interior 125 also in FIG. 3. Base 124 includes a front 126, middle 127 and back 128 for carrying each of the light emitting diodes 122 in each pixel group 121. Printed circuit board 123 positions the light emitting diodes 122 near front 126 as best seen in side views of FIGS. 3 and 4 wherein the light emitting diodes 122 extend beyond the front 126. Printed circuit board 123 is located near middle 127 but could be closer to front 126 or back 128. Back 128 fits into an opening 120 sized to carry one base 124; specifically shown in FIG. 4 with the opening 120 in the base 124 depicted as a side view wherein tang 129 is engaged in a snap fit relation to the opening 120.

A light shade 130 is shown in FIGS. 2, 3 and 4 extended cantilever from the base 124. Light shade 130 is located primarily above each of light emitting diodes 122 in the pixel groups 121 extending forwardly cantilever from base 124. Light shade 130 is configured for extend above each pixel groups 121 of light emitting diodes 122. Pixel group 121 is disposed for observation thereof from locations generally in front and slightly below the visual display 100 as shown in FIG. 1. Light shade 130 is facetted to reduce reflection of generally downwardly cast ambient light received by the visual display 100 from locations generally above the visual display and to prevent the downwardly cast ambient light from being reflected therefrom for observation see FIGS. 2, 3, 4, 5 and 6. In particular, FIG. 4 shows how the light reflected from base 124 beneath might reach pixel group 121 there above but for light shade 130.

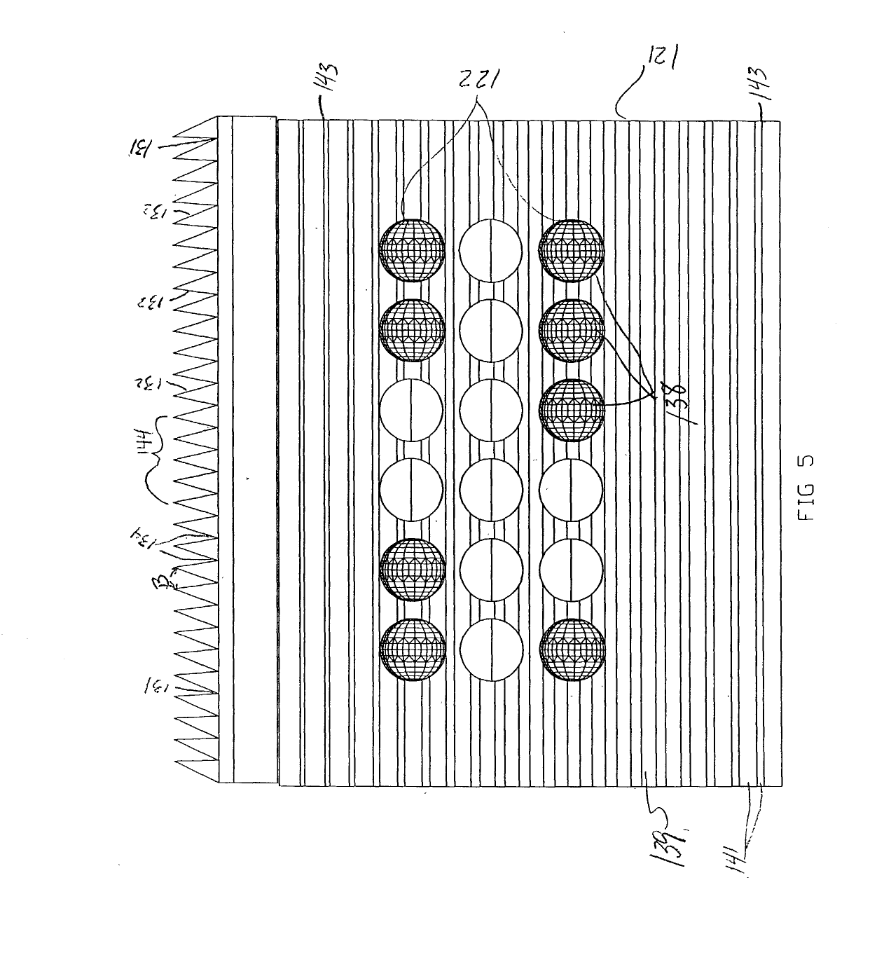

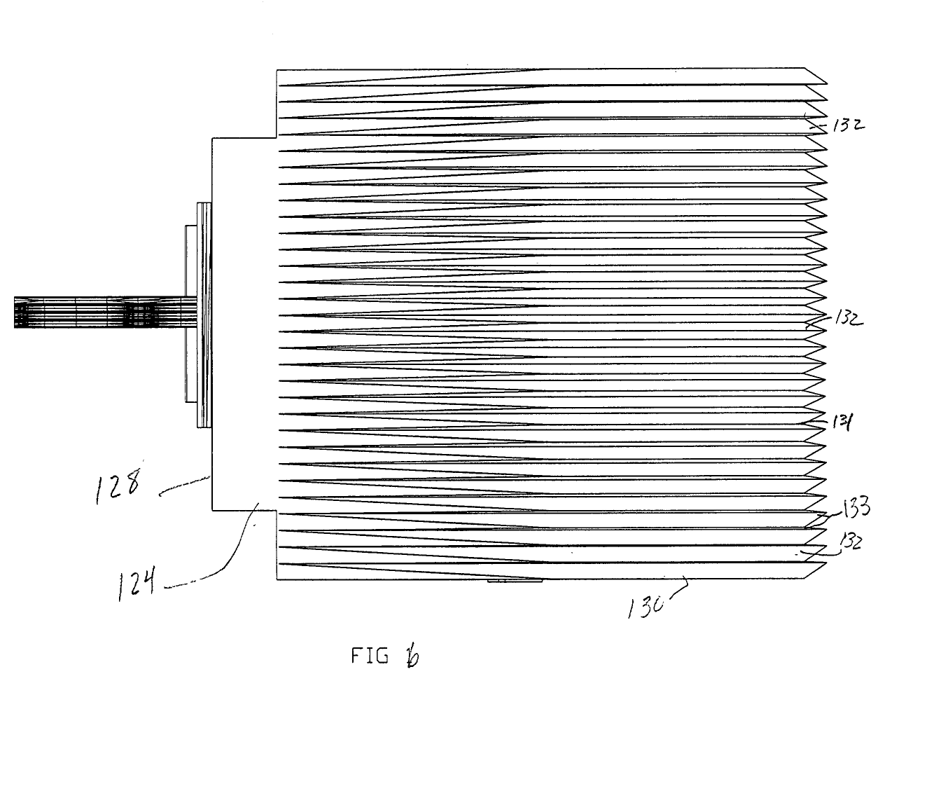

Light shade 130 includes a plurality of generally upwardly facing narrow crevices 131 in FIGS. 5 and 6 for absorbing light when support 101 is in a substantially vertical position as shown in FIG. 1 and carries base 124 normal there to substantially horizontally therefrom. Substantially vertical includes the slight downward angle in the range of 10 to 30, see “A” in FIG. 2, degrees from the horizontal typically used to provide the sight line shown between the observer 10 in visual display 100 shown in FIG. 1. This angle is shown in FIG. 2 and designated as “A”Light shade 130 has a plurality of light reflective surfaces 132 facing locations generally above visual display 100. The plurality of light reflective surfaces 132 is arranged so that pairs 133 of light reflective surfaces are opposed at an angle relative to one another to receive downwardly cast ambient light and reflect that ambient there between. The angle “B” is acute so that reflection of the received ambient is directed toward a narrow crevice 131 in FIG. 5. Each narrow crevice 131 is positioned whereat its respective pair 133 of light reflective surfaces 132 join acutely. These arrangements are best seen in FIG. 4 a front view of but one pixel group 121 base 124 and more particularly the light shade 130. Light shade 130 is tipped upwardly at and angle “C” in the range of five to ten degrees to the horizontal for maximum light trapping effect.

Each pixel group 121 has plurality of light emitting diodes 122 of different colors selected from the colors red, green or blue which by means of printed circuit board 123 are energized to create images with a full spectrum of color in a well known manner. Light emitting diodes 122 have intensity tolerances that can vary widely and skilled artisans understand how to measure and balance light intensities so that the resulting visual displays 100 look natural. One technique is to use more of the weakest intensity of color to offset the low output of that color consequently, FIGS. 2 and 5 have empty spaces for receiving more light emitting diodes 122. Thus pixel group 121 could have any number of red, blue or green light emitting diodes 122. The size of each pixel group 121 is immaterial under the teachings of the present invention. Depending on the size of visual display 100 and the distance of the observers 10, skilled artisans can select the number of pixel groups 121 needed to provide observable images.

Electronic drive circuitry 135 shown as a trace layer in the cut away of FIG. 3 is carried on printed circuit board 123 to selectively control the delivery of power to each light emitting diode 122 of pixel group 121. Each light emitting diode 122 see FIG. 3 has a chip 136, a reflector 137 and a colored lens 138 for dispersion of light essential toward locations generally in front of visual display 100. Reflector 137 may reside in a generally normal plane to the direction of light transmitted from light emitting diode 122 and normal to light shade 130 as in FIGS. 1 and 3. The colored lenses 138 of the light emitting diodes 122 are preferably shaped to produce an ovoid light pattern toward locations generally in front of visual display 100.

Consistent with the teachings of METHOD AND APPARATUS FOR LIGHT ABSORBING U.S. Ser. No. 09/964,004 filed on Sept. 25, 2001 by the same inventors and assigned to the same assignee, Mikohn Gaming Inc. of Las Vegas, Nev. the is a light absorber 139. Light absorber 139 in FIGS. 3, 4 and 5 has a plurality of generally horizontal opposing pairs 140 of reflecting surfaces 141 with each pair 140 joined in a narrow cranny 142. Plurality of generally horizontal opposing pairs 140 of reflecting surfaces 141 is positioned on front 126 of base 124 about each pixel group 121 thereon in FIGS. 1, 2 and 3. Light absorber 139 is carried in a generally normal to the sight line and spaced a preset distance “D” from reflector 137 while facing toward the direction of locations generally in front of the visual display 100 as in FIG. 3. Each colored lens 138 is select from the group, of red, blue, green, so the light emitting diodes 122 can be made to provide the desired color of light. Plurality of light reflective surfaces 141 face locations generally in front of visual display 100 so there is essentially no observed reflected ambient light.

Light absorber 139 presents about each pixel group 121 contrasting dark area background on visual display 100. The plurality of generally horizontal opposing pairs 140 of reflecting surfaces 141 are acutely angled with respect to each other so that the received ambient light bounces between the acutely angled opposing light reflective surfaces 141 toward each narrow cranny 142 there between. Adjacent pairs 140 of opposing light reflective surfaces 141 join forwardly at a plurality of sharp edges 143. Sharp edges 143 are horizontally disposed facing locations generally in front of visual display 100 so that as viewed in side view of FIG. 4 the plurality of adjacent pairs 140 of opposing light reflective surfaces 141 appear generally as a series of connected “WWW” configurations 144 in FIG. 3. The plurality of sharp edges 143 split received ambient light so that pairs 140 of reflective surfaces 141 in combination with the narrow crannies 142 located inwardly of the plurality of sharp edges 143 minimize reflection of ambient light. While light absorber 139 is generally planar the “WWW” configurations 144 can be skewed in FIGS. 3 and 4 with respect to the sight line so that the minimization of reflection is enhanced about the sight line. That is to explain that adjacent pairs 140 of opposing light reflective surfaces 141 can be arranged in FIG. 3 so that they point more toward the sight line than infinity. This effect is not as important for light shade 130 as the distance of the source of the downwardly cast ambient light are not one place. The plurality of light emitting diodes 122 each have a light pattern of that is ovoid toward locations for observation from in front of visual display 100 such that the ovoid pattern has a longer horizontal dimension. The series of connected “WWW” configurations 144 are also on light shade 130 formed by the plurality of adjacent pairs 133 of opposing light reflective surfaces 132 angle downwardly as seen in FIG. 5 to trap downwardly cast ambient light.

A method of shading downwardly cast ambient received on visual display 100 includes the steps of supporting visual display 100 in position for observation from locations generally in front of and slightly below visual display 100 and mounting printed circuit boards 123 on support 101. Each printed circuit board 123 includes electronic drive circuitry 135 for visual display 100. Further steps are coupling plurality of light emitting diodes 122 as pixel group 121 on each printed circuit board 123. Each light emitting diode 122 is coupled with terminals 129 in the cut away of FIG. 3 for electrically driving each of the plurality of light emitting diodes 122 with electronic drive circuitry 135. A step of light enhancement is cantilevering light shade 130 above each pixel group 121 to absorb downwardly cast ambient light and prevent reflection thereof to locations generally in front of and slightly below visual display 100. The steps of including on light shade 130 narrow crevices 131 facing upwardly for absorbing light and placing between narrow crevices 131 a plurality of light reflective surfaces 132 facing locations generally to receive downwardly cast ambient light are preformed. The mounting opposing pairs 133 of light reflective surfaces 132 acutely angled to receive and reflect downwardly cast ambient light there between and toward narrow crevice 131 are steps wherein each opposing pair 133 of light reflective surfaces 132 join acutely. The method has the step of mounting the printed circuit boards 123 including snapping base 124 at tang 129 having cube shape into openings 120 see FIGS. 2, 3 and 4 on support 101. The step of joining adjacent opposing pairs 133 of light reflective surfaces 132 at a plurality of sharp edges 143 form connected “WWW” configurations 144 is performed. The “WWW” configurations 144 split received downwardly cast ambient light so that pairs of reflective surfaces 133 in combination with narrow crevices 131 located inwardly of the plurality of sharp edges 143 reduce reflection of downwardly cast ambient light.

The steps of locating the plurality of narrow crannies 142 between the opposing acutely angled reflective surfaces 141 connected with sharp edges 143. In light absorber 139 the sharp edges 143 are generally horizontal and in front of the printed circuit boards 123 located about pixel groups 121. The light absorber 139 absorbs ambient light from locations generally in front of the visual display so that the dark area appear about each of light emitting diodes 122 is seen during observation.

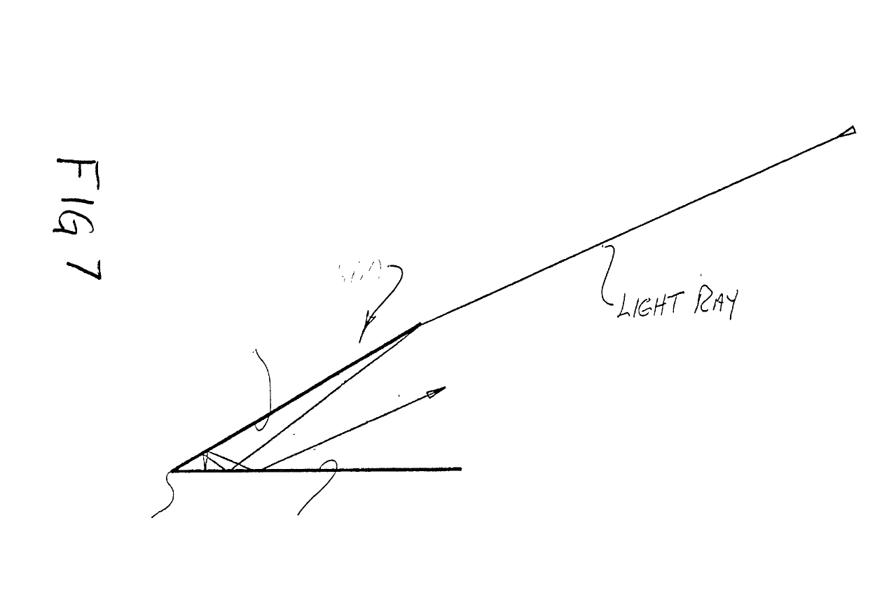

The FIG. 7 shows schematically the basic design and operation of the light shade 130 on but one illustrative light ray. One pair of reflective surfaces 132 is shown in solid bolder lines as would be seen schematically in cross section. The pair of reflective surfaces 132 is preferably two mirror like or specular surfaces preferably arranged at 30 degrees to each other. To be specular in the context of this disclosure, roughness above a part of the wavelength of the light ray to be absorbed must not be on the subject reflective surfaces 132. By way of example, if the downwardly cast ambient light ray were all red having a wavelength of 650 nanometers then the specification for the surface finish for the specular or reflective surfaces 132 would have to be a fractional part of that wavelength or for example, 300 nanometers. If by lines per inch or by other metrics, the specular or reflective surface specification could also be defined to a degree that skilled artisans understand and can produce.

In order to illustrate or analyze how light will travel (bounce) in FIG. 7 within light shade 130 reflective surfaces 132 are not shown unfolded as a the fan of black lines emanating or coming from the apex at narrow crevice 131 of the light shade 130. Unfolding the light rays is an approach common to physicists' to illustrating many rays and the locations of the reflective surfaces 132. In FIG. 7 it is easier to illustrate and describe how one light ray will travel within light shade 130 if the light shade is shown schematically and not in an unfolded layout. That is to explain that the reflective or specular surfaces 132 acutely angled at 30 degrees to each other are not shown as if they were rotated about their apex so there are a plurality of such reflective surfaces 132 angled at 30 degrees with respect to one another. The path of any light ray reflections is not diagrammed by using the unfolded layout, but the number of times the light ray is reflected (bounced) can be counted and the angle of each bounce can be found from simple geometry. At each bounce the intensity of each received downwardly cast ambient light ray will be reduced ninety four percent if surface is black.

A sample light ray that is passing within light shade 130 between reflective surfaces 132 bounces each time it strikes one of reflective or specular surfaces 132 as shown as a line in FIG. 7. The method for shading unwanted downwardly cast ambient light is to allow the light to bounce between the reflective or specular surfaces 132 as many times as possible, because light intensity is lost by ninety four percent each time the light ray bounces. As the light rays enter along paths that are off the central or bisecting axis, there would be fewer bounces possible. Thus it is preferred for this reason that narrow crevices 131 of light shade 130 be generally upward, see FIGS. 2, 4 and 5. Beneath and at the front of each light shade 130 is a beveled end 145 angled to minimized the reflection of ambient light from in front of the base 124 see FIGS. 2, 3 and 4. Extending from the beveled end 145 to the light absorber 139 is a smooth surface 146 for redirecting an light that impinges there upon to the light absorber 139 or the light shade 130 immediately there below as in FIGS. 3, and 4. Narrow crevices 131 can be curved, if desired, by angling reflective surfaces 132 seen best in FIG. 5. The curvature orients each narrow crevice 131 to face the preponderance of incoming light. Light shade 130 approaches mainly from above and typically from a greater distance.

Dust problems with the horizontal disposition of light absorber 139 are no worse than any other orientation. Power washing may be used to remove dust accumulation. If horizontal orientation is a problem, the narrow crannies 142 may be position in the vertical direction, but there will be an inherent loss in effectiveness with any off axis orientation of light absorber 139.

The configuration of the printed circuit board 123, the type of light emitting diodes 122 and the design of the electronic drive circuitry 135 are immaterial to the teachings of the present invention and could be of any suitable type including those disclosed in the references in the background of this disclosure that are now made a part hereof and are incorporated by reference. The claims which follow seek to include light shades 130 that when used with light emitting diodes 122 attenuate downwardly cast ambient light enabling any light emitting diode intensity to exhibit relatively more brightness, clarity and contrast. Those skilled artisans will appreciate that changes and modifications can be made to the disclosed structure of the light shade, the light emitting diodes and their bases without departing from the scope of the following claims.

I claim:

1. A visual display for observation comprising:
a support for mounting the visual display in position for observation of the visual display from locations generally in front and slightly below the visual display;
a plurality of openings on the support;
one or more pixel groups carried on the support;
a plurality of light emitting diodes in each pixel group, each of the plurality of light emitting diodes selectively illuminated for delivery of an image of the visual display;
a printed circuit board electrically coupled to the light emitting diodes of each pixel group for selectively and electrically driving each of the light emitting diodes;
a base having a generally cube shape with a hollow interior, the base with a front, middle and back for carrying each pixel group and its printed circuit board with the light emitting diodes near the front, the printed circuit board near the middle and the back held in one opening sized to carry one back of one base, each pixel group disposed on the base for observation thereof from locations generally in front and slightly below the visual display;
a light shade extended cantilever from the base toward locations in front of the visual display, the light shade located primarily above each pixel group of light emitting diodes, the light shade configured for extend above each of the pixel groups of light emitting diodes, the light shade facetted to reduce reflection of generally downwardly cast ambient light received by the visual display from locations generally above the visual display and to prevent the downwardly cast ambient light from being reflected therefrom for observation.

2. The visual display of claim 1 wherein the light shade includes a plurality of generally upwardly facing narrow crevices for absorbing light when the support is in a substantially vertical position and carries the base normal thereto.

3. The visual display of claim 2 wherein the light shade has a plurality of light reflective surfaces facing locations generally above the visual display, the plurality of light reflective surfaces arranged so that pairs of light reflective surfaces are opposed at an angle relative to one another to receive downwardly cast ambient light and reflect that ambient there between and toward the narrow crevice positioned whereat the pairs of light reflective surfaces join acutely.

4. The visual display of claim 2 wherein each pixel group has a plurality of light emitting diodes of different colors selected from the colors of red, green, blue.

5. The visual display of claim 4 wherein electronic drive circuitry in the printed circuit board selectively controls the delivery of power to each pixel group of light emitting diodes.

6. The visual display of claim 3 wherein each light emitting diode has a chip, a reflector and a colored lens for dispersion of light essential toward locations generally in front of the visual display, the reflector resides in a generally plane disposed normal to the direction of light transmitted from the light emitting diode and normal to the light shade.

7. The visual display of claim 6 wherein a light absorber having a plurality of generally horizontal opposed pairs of reflecting surfaces with each pair joined in a narrow cranny, the plurality of generally horizontal opposed pairs of reflecting surfaces positioned on the front of the base about each the pixel group thereon, so the light absorber is carried in a plane spaced a preset distance from the reflector while facing toward the direction of locations generally in front of the visual display.

8. The visual display of claim 6 wherein each colored lens is select from the group of red, blue, green and the plurality of light reflective surfaces face locations generally above the visual display so there is essentially no observed reflected downwardly cast ambient light.

9. The visual display of claim 7 wherein the light absorber presents contrasting dark area background of the visual display pixel groups.

10. The visual display of claim 7 wherein the plurality of generally horizontal opposed pairs of reflecting surfaces are acutely angled with respect to each other so that the received ambient light bounces between the acutely angled opposed light reflective surfaces toward each narrow cranny there between.

11. The visual display of claim 10 wherein adjacent pairs of opposed light reflective surfaces join at a plurality of sharp edges facing locations generally above or forward of the visual display so that if viewed in side cross section the plurality of adjacent pairs of opposed light reflective surfaces appear generally as a series of connected “WWW” configurations with the plurality of sharp edges facing locations generally above of in front of the visual display, the plurality of sharp edges for splitting received ambient light so that the pairs of reflective surfaces in combination with the narrow crevices or crannies located inwardly of the plurality of sharp edges minimize reflection of ambient light.

12. The visual display of claim 10 wherein the plurality of light emitting diodes each have a light pattern of that is ovoid toward locations for observation from in front of the visual display such that the ovoid pattern has a longer horizontal dimension.

13. The visual display of claim 11 wherein the series of connected “WWW” configurations on the light shade and formed by the plurality of adjacent pairs of opposed light reflective surfaces curve in a slight arc with respect to the downwardly cast ambient light such that if viewed from in front the curvature appears dished for trapping downwardly cast ambient light from locations generally above of the visual display.

14. A visual display for observation comprising:
a support for mounting the visual display in position for observation of the visual display from locations generally in front and slightly below the visual display;
a plurality of bases on the support;
at least one printed circuit board on each base, each printed circuit board including driving circuitry for the visual display;
a plurality of light emitting diodes in a pixel group, each pixel group carried on each printed circuit board, each light emitting diode having terminals for electrically coupling to the printed circuit board so each printed circuit board holds at least one pixel group illuminated forwardly for observation;
an electronic drive circuitry on each printed circuit board for selectively controlling the delivery of power to each of the plurality of light emitting diodes;
a light shade mounted to extend cantilever above each pixel group, each light shade configured for shading each of the plurality of light emitting diodes of each pixel group from downwardly cast ambient light for preventing observation from locations generally in front and somewhat below the visual display of reflection of downwardly cast ambient light, the light shade facetted with pairs of opposed light reflective surfaces each joined at one of a plurality of narrow crevices for absorbing downwardly cast ambient light received by the visual display from locations generally above the visual display and to prevent the downwardly cast ambient light from being reflected therefrom for observation, the pairs of opposed light reflective surfaces acutely disposed for facing locations generally above the visual display to receive downwardly cast ambient light and reflect it there between and toward the narrow crevice there between, the pairs of opposed light reflective surfaces each joined adjacently by one of a plurality of sharp edges for receiving downwardly cast ambient light.

15. A method of shading downwardly cast ambient received on a visual display comprising the steps of:
supporting the visual display in position for observation from locations generally in front of and slightly below the visual display;
holding a plurality of bases on the support disposed toward locations generally in front of and slightly below the visual display;
mounting printed circuit boards on the bases, each printed circuit board including circuitry for the visual display;
coupling a plurality of light emitting diodes as a pixel group to each printed circuit board with terminals for electrically driving the plurality of light emitting diodes with the circuitry;
cantilevering a light shade above each pixel group to absorb downwardly cast ambient light and to prevent reflection thereof to locations generally in front of and slightly below the visual display;
including on the light shade narrow crevices facing upwardly for absorbing light;
placing between the narrow crevices a plurality of light reflective surfaces facing locations generally to receive downwardly cast ambient light;
mounting opposed pairs of the light reflective surfaces acutely angled to receive and reflect the downwardly cast ambient light there between and toward the narrow crevice wherein each opposed pair of light reflective surfaces join acutely.

16. The method of shading downwardly cast ambient light of claim 15 with the step of mounting the printed circuit boards including snapping the base into an opening on the support.

17. The method of shading downwardly cast ambient light of claim 16 with the step of:
joining adjacent opposed pairs of light reflective surfaces at a plurality of sharp edges facing locations generally above the visual display for forming connected “WWW” configurations for splitting received downwardly cast ambient light so that the pairs of reflective surfaces in combination with the narrow crevices located inwardly of the plurality of sharp edges reduce reflection of downwardly cast ambient light.

18. The method of claim 17 with the steps of:
locating the plurality of narrow crannies, opposed acutely angled reflective surfaces and connecting sharp edges generally horizontal and in front of the printed circuit boards about the pixel groups to absorb ambient light from locations generally in front of the visual display so that dark area appears about each of the light emitting diodes during observation.
